(19) United States
(12) Patent Application Publication
(10) Pub. No.: US 2006/0272500 A1
(43) Pub. Date: Dec. 7, 2006

(54) System and method for removing volatile and semi-volatile compounds from an aqueous stream

(76) Inventors: Arturo Alejandro Keller, Santa Barbara, CA (US); Michael John Joy, Newbury Park, CA (US); Lawrence Neill, Camarillo, CA (US); Mark Alan Galliher, Thousand Oaks, CA (US)

Correspondence Address: CHRISTIE, PARKER & HALE, LLP, PO BOX 7068, PASADENA, CA, 91109-7068, US

(21) Appl. No.: 11/147,583

(22) Filed: Jun. 7, 2005

(51) Int. Cl. B01D 53/22

(52) U.S. Cl. 95/46

(57) ABSTRACT

A method of removing volatile and semi-volatile compounds from an aqueous stream is provided which may include injecting a scale reducing gas having a primarily inert gas containing carbon dioxide into the aqueous stream; flowing the stream past a first surface of a wall of a microporous, hydrophobic gas separation membrane that is substantially impermeable to water but is permeable to vapors from the volatile and semi-volatile compounds; applying a vacuum to a second surface of the wall of the membrane to draw the vapors of the compounds through the wall of the membrane; flowing a sweep gas from the first surface of the wall to the second surface of the wall to facilitate movement of the vapors through the wall of the membrane, wherein the sweep gas is a primarily inert gas containing carbon dioxide; and flowing the drawn vapors through an oxidation device to oxidize the drawn vapors.

### FIELD OF THE INVENTION

This application relates to the removal of volatile and semi-volatile organic and inorganic compounds from an aqueous stream and, more particularly, this invention relates to a system that involves the enhanced transfer of volatile and semi-volatile compounds through the wall of a hollow fiber membrane and the subsequent oxidation of the transferred compounds in the gas phase.

In one embodiment, a primarily inert gas, including a percentage of carbon dioxide, is injected into an aqueous stream prior to injecting the aqueous stream into a hollow fiber membrane to minimize the deposition of precipitates (also known as scaling) in the system. Heating this gas may be done to enhance the efficiency of the removal process. Another primarily inert gas, including a percentage of carbon dioxide, may be used as a “sweep” gas to transport the volatile and semi-volatile compounds to an oxidation device and at the same time help reduce scaling in the system.

### BACKGROUND OF THE INVENTION

Water containing volatile and semi-volatile compounds is produced in industrial processes, through the extraction of water from subsurface aquifers, from contaminated bodies of surface water, or by the use of water to remove volatile and semi-volatile compounds from contaminated soils. Many of these compounds are toxic. These aqueous streams must be treated to reduce the presence of these compounds to acceptable levels before the water can be reused or discharged. Many of the known water treatment systems directly treat the water to remove or reduce the level of contaminants. However, in many circumstances these systems are not cost effective and in some cases do not reduce the concentration of contaminants to an acceptable level.

Some of the known processes to remove volatile and semi-volatile organic compounds from water include (1) air-stripping; (2) adsorption onto activated carbon or other sorbents; (3) oxidation in the aqueous phase using ozone, hydrogen peroxide, UV radiation; and (4) biodegradation.

These known processes each have disadvantages. For example, for efficient volatile organic compound (VOC) removal by air-stripping requires a much larger foot print than the current invention. Also, the air to water ratio required for successful air-stripping is 10 to 100 time greater than that of the current invention's requirements, therefore the current invention significantly reduces the cost of treating the process air stream prior to emission to the atmosphere; in the adsorption process, the adsorption of organic compounds in the liquid phase is relatively inefficient; and in the oxidation process the oxidation of organic compounds is relatively inefficient in the liquid phase, since the concentration of oxidants is low.

A method has been described in U.S. Pat. No. 4,960,520 which involves the use of hollow fiber membranes to remove VOCs. This patent teaches the use of oil as the stripping solvent on the outside of the hollow fibers. However, this approach is not commercially viable since it is difficult and costly to separate the VOCs from the oil or to destroy the VOCs within the liquid oil carrier. Using oil as the stripping solvent generates an additional contaminated waste stream that must be disposed of at a relatively large cost.

Groundwater and most industrial wastewater streams contaminated with VOCs have a significant hardness, resulting from dissolved carbonates and other minerals. If the aqueous stream is passed through a VOC removal system without any pretreatment, minerals commonly precipitate in the system once the VOCs are removed, a phenomenon commonly referred to as scaling. Accordingly, a need exists for an improved system for removing volatile or semi-volatile compounds from an aqueous stream.

### SUMMARY OF THE INVENTION

In accordance with one embodiment of the invention, an aqueous stream containing volatile and semi-volatile organic compounds enters a treatment system and is passed on an inner side of a wall of hollow fibers while a vacuum is applied to an outer side of the fibers. To reduce the formation of mineral deposits or scaling in the stream, a primarily inert gas containing a percentage of carbon dioxide is injected into the stream before it passes through the hollow fibers. Such a primarily inert gas containing a percentage of carbon dioxide may also be used as a sweep gas for transporting the compounds across the fiber walls and to an oxidation module. Each primarily inert gas containing carbon dioxide may be produced by the oxidation module, which is primarily used to destroy the volatilized organic compounds.

As the volatile and semi-volatile compounds are transported across the fibers, the compounds are transformed from a liquid phase to a gas phase. The organic compounds are then destroyed in the oxidation module through a thermal, chemical or catalytic oxidation, or they are adsorbed pending future treatment.

The inlet contaminated aqueous stream may also be heated using waste heat from the oxidation module. In one embodiment, the hollow fibers are made of hydrophobic materials, such as polyolefins or other polymers, which retain water inside the hollow fibers, allowing only gases, such as volatile and semi-volatile compounds to transfer through the porous membrane wall. The fibers may be bundled in a container, denominated a membrane module, with separate inlet and outlet ports for the water and gaseous phases. The process can be used to treat industrial wastewater, water from contaminated aquifers and fossil fuel reservoirs, and/or water contaminated through other remediation processes used to remove organic compounds from contaminated soils or other materials.

For the same removal efficiency, a hollow fiber module is much smaller than an air stripping tower. Sorption of the organic compounds in the gas phase is more efficient than absorption in the liquid phase and higher quality products in higher concentration are produced. Furthermore, absorption in the liquid phase can result in fouling the absorbent with other contaminants. A hydrophobic membrane can be utilized that is selective to the removal of certain organic gas phase compounds. The concentration of an oxidizing agent and/or catalyst can be higher in the gas phase resulting in much higher efficiency. Since the residence time of the aqueous stream in the hollow fiber separation module is so small compared to a biodegradation process for equivalent efficiency, the module can be much smaller than a biodegradation reactor.

Other features and advantages of the present invention will become apparent from the following detailed description, taken in conjunction with the accompanying drawings which illustrate, by way of example, the features of the present invention.

### BRIEF DESCRIPTION OF THE DRAWINGS

FIG. 1 is a schematic representation of a system for removing volatile or semi-volatile compounds from an aqueous stream, including a hollow fiber membrane module together with an oxidizing unit for removal of volatile organic compounds (VOCs) from the gas effluent from the module with subsequent destruction of the vapor phase VOC through the oxidizing unit, also shown are injection points for entry of a primarily inert gas containing carbon dioxide into the aqueous stream and for a sweep gas for scale control;

FIG. 2 is a cross-sectional view of a hollow fiber membrane according to one embodiment of the invention;

FIG. 3 is a graph of flow rate versus VOC removal percent for several different conditions;

FIG. 4 is a graph illustrating theoretical vs. experimental compound removal efficiency;

FIG. 5 is a series of curves showing typical removal efficiencies vs. temperature;

FIG. 6 shows a schematic representation of alternatives for supplying heat to the system of FIG. 1;

FIG. 7 shows a schematic representation of further alternatives for supplying heat to the system of FIG. 1; and.

FIG. 8 is a schematic representation of a system for removing volatile or semi-volatile compounds from an aqueous stream according to an alternative embodiment of the invention.

### DETAILED DESCRIPTION OF THE DRAWINGS

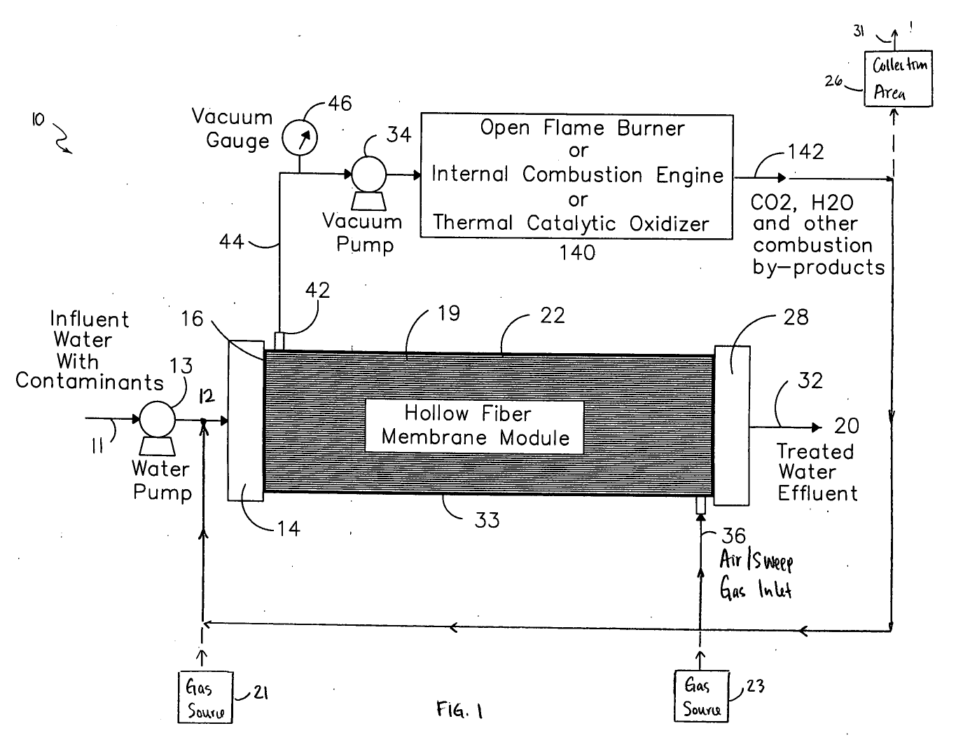

As shown in FIGS. 1-8, embodiments of the present invention are directed to a system for removing volatile or semi-volatile compounds from an aqueous stream. The system transforms volatile and semi-volatile compounds, individually or as a mixture, from the aqueous stream to a gas stream by passing the aqueous stream through hydrophobic hollow fiber membranes and applying a vacuum pressure on one side of the fibers, preferably an outside surface of the fibers. The volatized compounds are transported across the wall of the fibers, and are removed preferably by the use of a sweep gas, and then destroyed using thermal oxidation (e.g. direct firing in a burner or in an internal combustion engine), or though chemical oxidation (e.g. adding strong oxidants such as ozone, peroxides to the compound) which may be accelerated through the use of ultraviolet radiation (UV) or catalytic activity, or they are adsorbed pending future destruction. The overall process of removal and destruction of the compounds is illustrated in FIG. 1 and described in detail below.

To improve the long-term efficiency of the removal process, a primarily inert gas containing carbon dioxide is injected into the inlet contaminated aqueous stream and may also be used as the sweep gas, to reduce the formation of mineral deposits, or scaling. The primarily inert gas containing carbon dioxide may be generated by the gas-phase oxidation process. Waste heat from the oxidation process may also be used to preheat the inlet contaminated aqueous stream to improve overall mass transfer.

As shown in FIG. 1, in one embodiment, an aqueous stream 11 containing volatile and semi-volatile compounds, is pumped by means of a pump 13 into an inlet manifold 14 of a system 10 for removing volatile or semi-volatile compounds from the aqueous stream 11. Typically the stream is an extraction of contaminated water from subsurface aquifers or oil reservoirs, from contaminated surface water bodies, or from the use of remediation systems. As shown, adjacent to the inlet manifold 14 is a shell 33 containing a plurality of hydrophobic hollow fiber membranes 19 having lumens 16. The pump 13 directs the contaminated water 11 into the lumens 16 of the hollow fiber membranes 19.

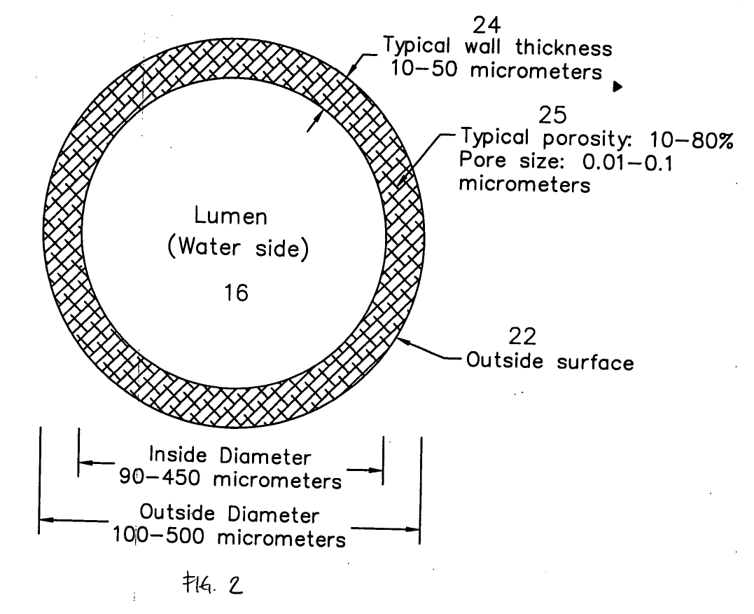

In one embodiment, prior to pumping the aqueous stream 11 into the manifold 14, a primarily inert gas containing carbon dioxide is injected at point 12 to reduce scaling in the stream 11. As the stream 11 is transported longitudinally through the fibers 19 (i.e., from left to right as shown in FIG. 1) a vacuum pump 34 is applied to a outside surface 22 of the fibers 19. Due to the hydrophobic nature of the fibers 19, the stream 11 stays within the lumens 16 and does not transfer in significant amounts across the fiber walls 24 (see FIG. 2) to the outside surface 22 of the fibers 19. The volatile and semi-volatile compounds, on the other hand, as well as gases dissolved in the aqueous stream 11, may transfer through the walls 24 in an external gas phase.

As shown in FIG. 1, adjacent to the hollow fibers 19 opposite from the inlet manifold 14 is an outlet manifold 28. The concentration of volatile and semi-volatile compounds in the stream 11 as it enters the outlet manifold 28 is significantly reduced by the extraction of the compounds through the fiber walls 24. As such, treated water 20 exits the manifold 28 through line 32. Additional removal can be achieved by placing membrane modules 19 in series.

In one embodiment, a sweep gas is drawn into the shell 33 by means of the vacuum pump 34 through inlet 36. The sweep gas flushes the volatile and semi-volatile compounds after they transfer transversely across the membrane 19, and exits the outside surface 22 of the fibers 19.) The contaminant laden sweep gas then leaves the shell 33 through an outlet 42 and flows through a line 44 and vacuum pump 34.

The efficiency of the compound removal is dependent on the vacuum pressure applied to the outside surface 22 of the fibers 19, i.e., higher vacuum pressures result in higher removal efficiencies. The removal efficiency also depends on the temperature of the stream 11, i.e., higher stream temperatures result in more volatilization of the volatile and semi-volatile compounds, increasing the removal efficiency.

In one embodiment, the hydrophobic hollow fibers 19 are fabricated from polyolefins and other polymers. The fibers 19 have a certain porosity (typically from 10 to 80%, with pores, represented by reference numeral 25, in the range from 0.01 to 0.1 μm), which allows the movement of hydrophobic organic molecules as gases across the wall 24 of the fibers 19. In one embodiment, the hollow fibers 19 have a large surface area for transfer of the hydrophobic volatile and semi-volatile compounds.

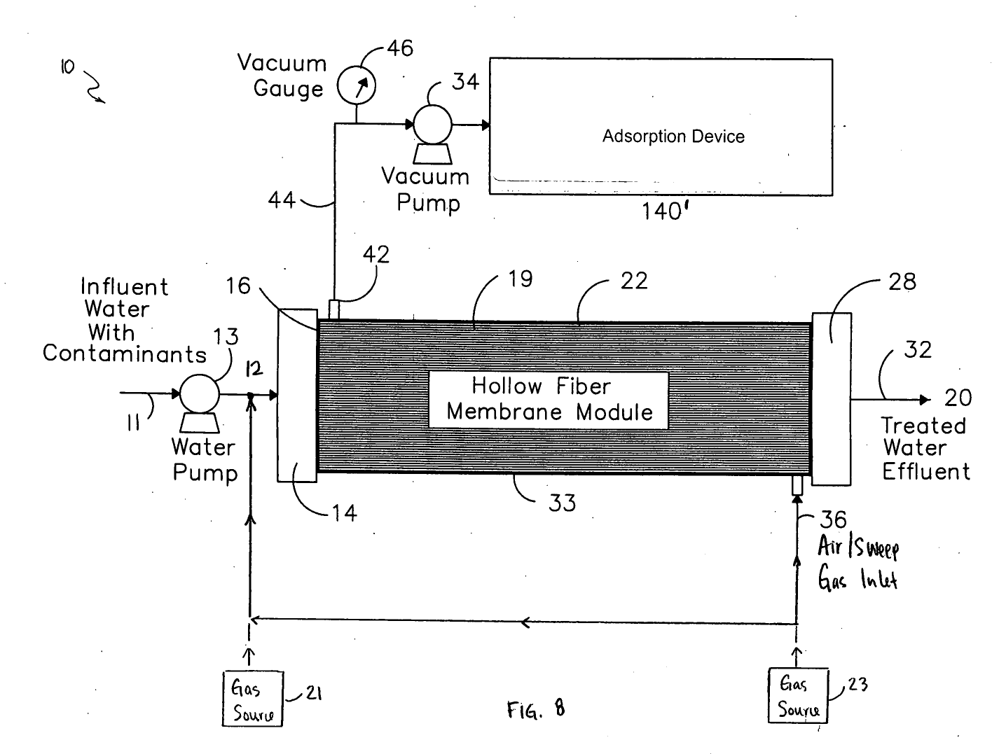

As shown in FIG. 1, the volatile and semi-volatile compounds collected in the hollow fiber module shell 33 are drawn by vacuum pump 34 into a direct combustion unit 140, such as an open flame burner, an internal combustion engine, a thermal oxidizer, a catalytic oxidizer, or combination thereof, among other suitable combustion devices. In an embodiment where the combustion unit 140 is an internal combustion engine, an intake manifold vacuum on the engine may be used as the above described vacuum pump 34. The combustion unit 140 combusts the organic compound vapors combusted to form CO₂, H₂O and other combustion products which leave the combustion unit 140 through exhaust line 142. In an alternative embodiment, as shown in FIG. 8, the process is as described above with respect to FIG. 1 except that instead of oxidizing the drawn volatile and semi-volatile compounds in a combustion unit 140, the drawn volatile and semi-volatile compounds are directed to an adsorption device 140′.

In one embodiment, some or all of the energy produced by the oxidation in the combustion unit 140 can be utilized to power either or both of the pumps 13 and 34, and/or to heat the incoming aqueous stream 11. In another embodiment, some or all of the exhaust gas from the internal combustion engine can be transported from line 142 to inlet 36 and used as the sweep gas to decrease scale formation. Alternatively, or in addition, some or all of the exhaust gas from the internal combustion engine can be transported from line 142 to inlet 12 to mix with the aqueous stream 11 prior to its introduction to the hollow fiber shell 33 to improve scale reduction. The exhaust gases exiting the combustion unit 140 through outlet 142 are primarily inert gases including CO₂, H₂O and other oxidation by-products.

As shown in dashed lines in FIG. 1, in one embodiment an outside gas source 21 is used to supply a gas to the aqueous stream 11 at inlet 12. As is also shown, in one embodiment an outside gas source 23 is used to supply the sweep gas to the sweep gas inlet 36. The gas from each source 21 and 23 may be a primarily inert gas containing carbon dioxide. Also shown in dashed lines, in one embodiment the exhaust gases from the combustion unit 140 may be directed to a collection area 26. The exhaust gases may then be vented to the atmosphere as shown by arrow 31.

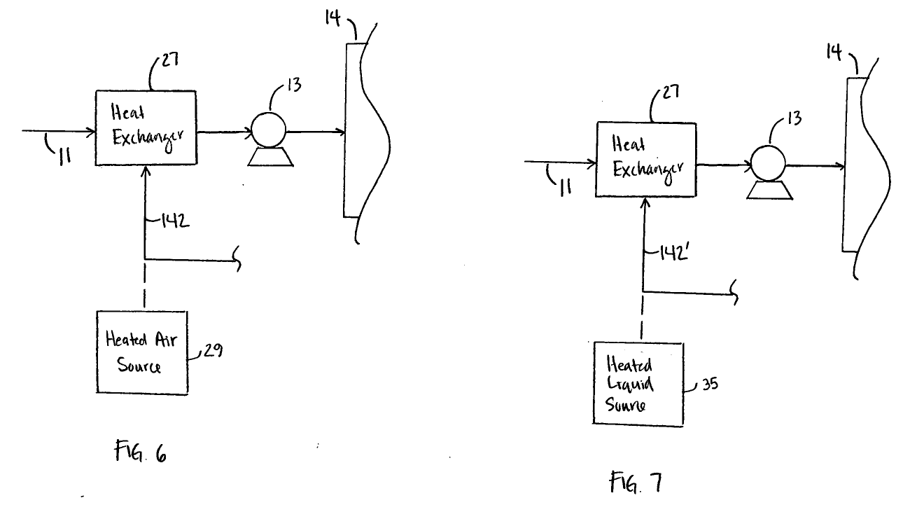

In the embodiment of FIG. 6, a heat exchanger 27 is added before the water pump 13. Although, in alternative embodiments, the heat exchanger 27 may be added anywhere before introduction of the aqueous stream 11 to the inlet manifold 14. The heat exchanger 27 may receive heated air either from an external heat source 29 or from the exhaust gases of the combustion unit 140 through line 142. In either case, the heat exchanger 27 provides additional heat to the aqueous stream 11. In a further alternative, as shown in FIG. 7, the heat exchanger 27 may receive a heated liquid either from an external source of a heated liquid 35 or from the combustion unit 140 through a line 142′.

The volatile and semi-volatile compounds can also be destroyed by chemical oxidation. An oxidizing agent such as oxygen, ozone and/or hydrogen peroxide may be present in the abatement device. Oxidation may also be promoted by UV radiation.

VOC contaminated aqueous streams from industrial processes usually contain from 10 μg/l to 50,000 μg/l of dissolved, volatile and semi-volatile organic compounds, which can include hydrocarbons, halocarbons and oxygen containing compounds such as tetrachloroethylene (TCE), benzene, methyl tert butyl ether (MTBE), halogenated organic pesticides, organophosphate pesticides, alcohols, ketones, esters, aldehydes, etc. Inorganic volatile and semi-volatile compounds such as sulfur and nitrogen based compounds can also be removed from the aqueous stream. The concentration of the compounds in the aqueous stream is significantly reduced, typically by at least 90%, and under certain conditions by more than 99% by the removal system 10 according to the present invention.

The rate and efficiency of removal depends on the porosity of the fibers 19, the length of the fibers 19, pore size 25 of the fibers 19, wall thickness 24 of the fibers 19, the temperature and flow rate of the aqueous stream 11, and the temperature and vacuum pressure on the outside surface 22 of the fibers 19.

In one embodiment, the hollow fibers 19 are formed from a microporous synthetic resin. In such an embodiment, a porosity of 10 to 80% provides efficient transfer rates and a pore size between 0.001 to 1 μm, preferably 0.01 to 0.1 μm, provides selectively for gas phase transfer of the volatile and semi-volatile compounds through the wall 24 of the hollow fibers 19. The wall thickness 24 is typically in the range of 1-100 μm, and preferably from 10 to 50 μm. Hollow fibers 19 having outside diameters from 100 μm to 500 μm are commercially available.

The aqueous stream 11 can flow through the lumens 16 of the fibers 16 or outside the wall 24 of the hollow fibers 19. Liquid flow through the lumen 16, however, minimizes collapse or rupture of the wall 24 of the fibers 19. The vacuum pressure produced by the vacuum pump 34 on the inside or outside surface 22 of the fibers 19 is typically from 5-29 in. Hg. A vacuum gauge 46 may be used to read the pressure from the vacuum pump 34. The temperature of the aqueous stream 11 is typically from 35° F. to 185° F., preferably from 40° F. to 140° F. The temperature of the sweep gas is usually ambient, or may be heated to increase removal efficiency.

The following experiments were conducted to demonstrate the effectiveness of separating volatile and semi-volatile organic compounds from an aqueous stream 11 by hollow fiber gas separation followed by combustion of the separated gases in an internal combustion engine using the above removal system 10.

This study used a pilot-scale membrane system for the removal of Methyl tert-Butyl Ether (MTBE) from water. The hydrophobic membrane fibers 19 allow for efficient transfer of volatile and semi-volatile compounds from the aqueous to gas phases. While the water is pumped through the hollow fibers 19, volatile components diffuse through the gas-filled pores of the hollow fiber 19, due to the large concentration gradient. The volatile and semi-volatile compounds are then pulled through the fibers 19 by a vacuum pump 34.

Experiments examined removal efficiency at various water and air flow rates, as well as three water temperatures (22, 30 and 40° C.). In the experiments, the hollow fiber membrane shell included 5,000 hollow polypropylene fibers with an overall mass transfer area of 1.4 m² and effective fiber length of 0.2 m. Reagent grade MTBE (Fischer) was used in all the studies. De-ionized water was spiked with a known amount of MTBE to prepare the aqueous stream for treatment. Contaminant concentrations ranged from 0.01 to 50,000 μg/l.

The aqueous stream was pumped through the lumen side of bundled microporous hollow fibers at flow rates ranging from 0.2 to 2 L/min. Sweep gas was drawn counter-currently on the outside of the fibers using a vacuum pump. Vacuum pressures ranged from 360 to 730 mm Hg (0.47 to 0.96 atm). Gas phase flow rates ranged from 11.3 to 39.7 L/min. The gas phase was passed through activated carbon filters to sorb the MTBE vapors. Water effluent was collected in a separate tank.

Water samples were collected immediately before and after the fiber shell. Samples were extracted using a solid-phase microextraction (SPME, 100 um polydimethyl siloxane fiber) fiber and analyzed in an HP 5890 gas chromatograph coupled to an HP 5970 Mass Spectrometer.

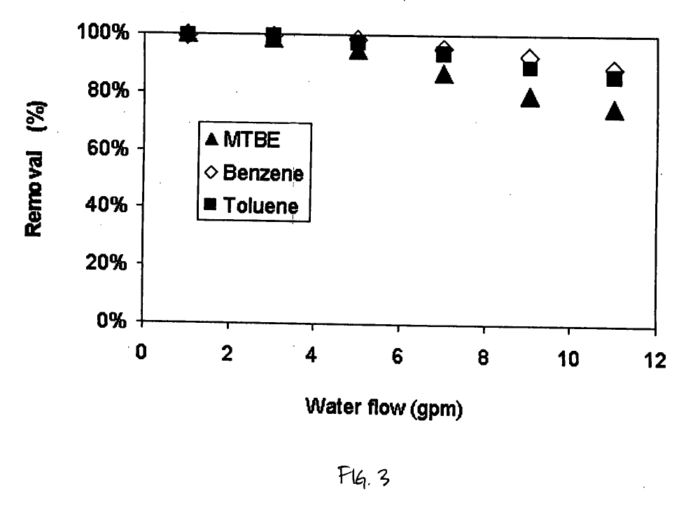

FIG. 3 represents the results from runs at different operating conditions. These results have been analyzed using a two-resistance model for the overall mass-transfer coefficient. Theoretical removal efficiency can be estimated using this model.

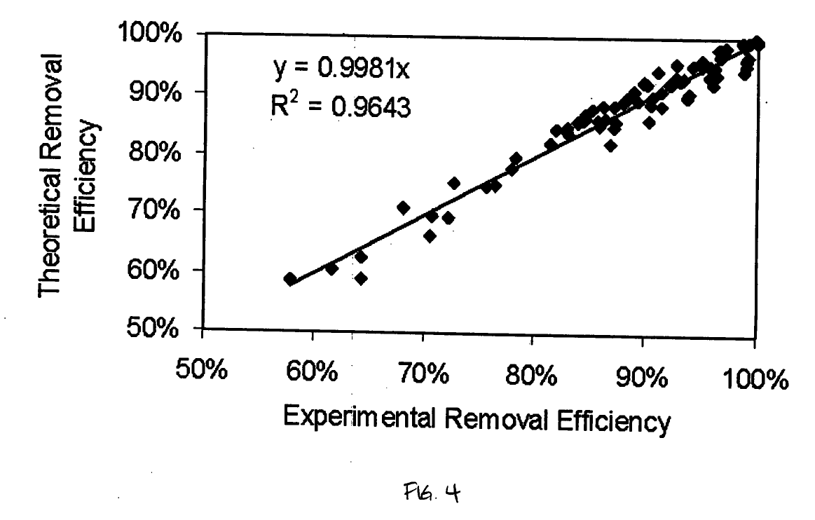

FIG. 4 represents the results of a comparison between observed experimental removal efficiency and theoretical removal efficiency.

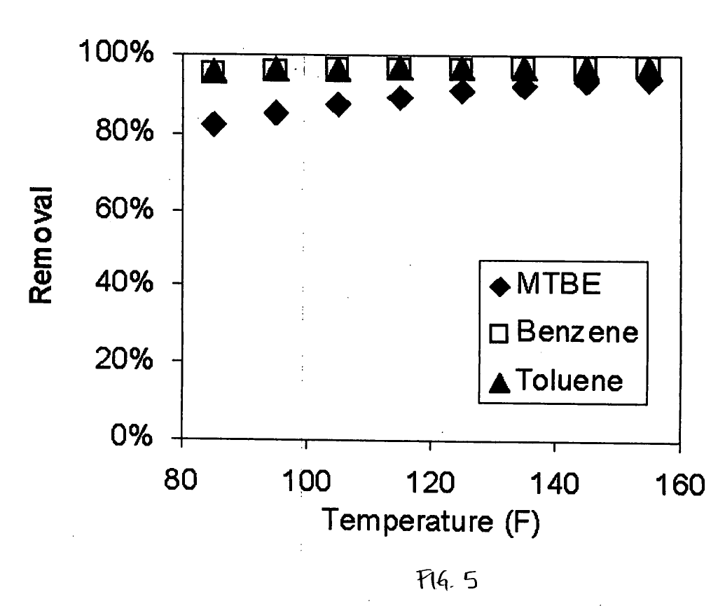

Using the design equations for the overall mass transfer coefficient, a field scale unit capable of handling 76 L/min (20 gpm) was evaluated in terms of its expected removal efficiency. The results are represented in FIG. 5. These studies clearly indicate that the removal system 10 is sufficiently efficient to be operated at a commercial level.

The preceding description has been presented with reference to various embodiments of the invention. Persons skilled in the art and technology to which this invention pertains will appreciate that alterations and changes in the described structures and methods of operation can be practiced without meaningfully departing from the principle, spirit and scope of this invention.

What is claimed:

1. A method of removing volatile and semi-volatile compounds from an aqueous stream comprising the steps of:
flowing the stream past a first surface of a wall of a microporous, hydrophobic gas separation membrane that is substantially impermeable to water but is permeable to vapors from the volatile and semi-volatile compounds;
applying a vacuum to a second surface of the wall of the membrane to draw the vapors of said compounds through the wall of the membrane;
flowing a sweep gas from a gas inlet to a gas outlet of the membrane to facilitate movement of the vapors out of the membrane, wherein the sweep gas is primarily an inert gas containing carbon dioxide; and
flowing the drawn vapors through an oxidation device to oxidize the drawn vapors.

2. The method according to claim 1, further comprising injecting a scale reducing gas comprising primarily an inert gas containing carbon dioxide into the aqueous stream before the step of flowing the stream past the first surface of the wall of the microporous, hydrophobic gas separation membrane.

3. The method according to claim 1, wherein the oxidation device supplies heat to increase the temperature of the aqueous stream.

4. The method according to claim 1, wherein the oxidation device supplies the sweep gas.

5. The method according to claim 1, wherein the oxidation device supplies the scale reducing gas.

6. The method according to claim 1, wherein the oxidation device is an internal combustion engine which supplies the sweep gas, the scale reducing gas and heat to increase the temperature of the aqueous stream.

7. The method according to claim 1, wherein the membrane is in the form of a hollow fiber having an interior lumen through which the aqueous stream flows.

8. The method according to claim 7, wherein the fiber is formed from a hydrocarbon polyolefin resin.

9. The method according to claim 7, wherein the fiber is formed of a polyalkylene formed from a monomer comprising from 1-8 carbon atoms and selected from the group comprising polyethylene and polypropylene.

10. A method according to claim 9, wherein the membrane wall has a porosity from 10-80%, the pores in the membrane wall are from 0.01 to 1 μm in diameter, and the fiber has an outside diameter from 1 to 500 μm and a wall thickness from 1 to 100 μm.

11. The method according to claim 1, wherein the compounds are present in the aqueous stream in an amount from 0.01 μg/l to 50,000 μg/l, and wherein at least 90% of the compounds are drawn across said wall of the membrane to be oxidized by the oxidation device.

12. The method according to claim 1, wherein the membrane is in the form of a plurality hollow fibers arranged in parallel and sealed into a container to form a gas separation module and the aqueous stream is flowed into the lumens of the fibers.

13. A system for removing volatile and semi-volatile organic compounds from an aqueous stream comprising:
an injection module comprising:
an inlet which receives a scale reducing gas comprising a primarily inert gas containing carbon dioxide;
a separation module comprising:
a shell having a first end and a second end;
a hydrophobic, microporous gas separation membrane extending from said first end to said second end, and comprising a first surface and a second surface dividing the shell into a liquid flow compartment and a gas separation compartment;
a liquid inlet manifold connected to said first end of the shell in communication with the liquid flow compartment;
a liquid outlet manifold connected to said second end of the shell in communication with the liquid flow compartment;
a vapor outlet connected to said shell in communication with the gas separation compartment;
a sweep gas inlet connected to the shell in communication with the gas separation compartment;
a vacuum source connected to said vapor outlet, such that as the stream flows through said liquid flow compartment, said compounds are drawn through said membrane into said gas separation compartment and are swept by said sweep gas out said vapor outlet; and
an oxidation module having an inlet which receives the drawn compounds from said vapor outlet and oxidizes said compounds.

14. The system according to claim 13, wherein the oxidation module supplies heat to increase the temperature of the aqueous stream.

15. The system according to claim 13, wherein the oxidation module supplies the sweep gas.

16. The system according to claim 13, wherein the oxidation module supplies the scale reducing gas.

17. The system according to claim 13, wherein the oxidation module is an internal combustion engine which supplies the sweep gas, the scale reducing gas and heat to increase the temperature of the aqueous stream.

18. The system according to claim 13, wherein the membrane comprises a plurality of microporous, hydrophobic gas separation hollow fibers having interior lumens which define the liquid flow compartment.

19. The system according to claim 18, wherein said fibers comprise a hydrocarbon resin.

20. A method of removing volatile and semi-volatile compounds from an aqueous stream comprising the steps of:
flowing the stream past a first surface of a wall of a microporous, hydrophobic gas separation membrane that is substantially impermeable to water but is permeable to vapors from the volatile and semi-volatile compounds;
applying a vacuum to a second surface of the wall of the membrane to draw the vapors of said compounds through the wall of the membrane;
flowing a sweep gas from a gas inlet to a gas outlet of the membrane to facilitate movement of the vapors out of the membrane, wherein the sweep gas is primarily an inert gas containing carbon dioxide; and
directing the drawn vapors to an adsorption device.
